(19) United States
(12) Patent Application Publication
(10) Pub. No.: US 2023/0097846 A1
(43) Pub. Date: Mar. 30, 2023

(54) REVERSE THREADING PROTECTORS FOR A TORQUE-LIMITING NUT

(71) Applicant: Stemco Products, Inc., Charlotte, NC (US)

(72) Inventors: Larry Seeds, Charlotte, NC (US); Mark Gold, Hallsville, TX (US); Herman Goins, JR., Kilgore, TX (US)

(21) Appl. No.: 17/946,699

(22) Filed: Sep. 16, 2022

Related U.S. Application Data
(60) Provisional application No. 63/250,104, filed on Sep. 29, 2021.

(51) Int. Cl. F16B 31/02

(52) U.S. Cl. CPC F16B 31/02

(57) ABSTRACT

A torque-limiting nut is provided. The torque-limiting nut is a unitized assembly with a washer, a threaded component, and a tool interface. A reverse thread protector engages the tool interface and washer to inhibit reverse threading once the nut is seated.

### CROSS-REFERENCE TO RELATED PATENT APPLICATIONS

The present application claims priority to U.S. Provisional Patent Application No. 63/250,104, titled “REVERSE THREADING PROTECTORS FOR A TORQUE-LIMITING NUT,” filed Sep. 29, 2021, which is related to U.S. patent application Ser. No. 17/069,635, titled “TORQUE-LIMITING NUT,” filed Oct. 13, 2020, which claims priority to U.S. Provisional Patent Application Ser. No. 62/915,122, filed Oct. 15, 2019, titled “TORQUE-LIMITING NUT,” the disclosures of which is incorporated by reference as if set out in full.

### BACKGROUND

Nut assemblies are well known implements that are generally used to hold an object in place. Nut assemblies may be used in numerous applications. In one application, a nut assembly may be used to hold a wheelend assembly on a spindle or vehicle axle.

Conventionally, nut assemblies comprise a nut and a washer that are operably coupled. The nut of the nut assembly is typically a metal or composite part with a threaded bore. The threads operatively engage corresponding threads on the spindle, for example. The nut assembly is screwed onto the spindle and tightened against the object (wheelend) to be held in place.

While simple in concept, tightening the nut assembly to hold a wheelend assembly on the spindle is complex. The nut assembly requires tightening to a particular torque to provide sufficient seating force to hold the nut assembly in place and preload the bearings, but excessive torque may, in certain implementations, cause damage to the part(s) or make removal difficult. Many nut assemblies, including spindle nut assemblies, require the use of complex procedures and a torque wrench to properly seat the nut assembly against the object (wheelend).

Even when tightened properly, the wheelend assembly operates in a harsh operating environment. One harsh operating environment characteristic includes vibration. The vibration may cause portions of the nut assembly to reverse thread, which is generally known as backing off.

Thus, against this background, a reverse threading protector for a torque-limiting spindle nut is desirous. Such a reverse threading protector should inhibit unwanted reverse threading but still allow for removal of the torque-limiting spindle nut.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

In some aspects of the technology, reverse threading protectors for a torque-limiting spindle nut are provided. The reverse thread protector may engage the tool interface and washer to inhibit reverse threading once the nut is seated. The engagement may comprise a first part on the tool interface and a second part on the washer.

In some embodiments, the first part is male component and the second part is a female component. The male component may be one or more protrusions or nibs. The female part may be one or more divots or recess. The female part may include one or more divots with asymmetrical ramps.

In some embodiments, the first part is a male component and the second part is a female component. The male component may be a pawl mechanism. The female component may be a divot or a plurality of divots. The plurality of divots may be formed by wedge shaped ramps on an outer perimeter sidewall of the washer. The pawl mechanism may comprise a lever and arm operationally coupled as a rocker arm. The arm terminates in a hook that engages at least one divot when the lever is not seated. When the lever is seated, the arm disengages the hook from the plurality of divots.

The reverse threading protectors may also comprise in certain embodiments a locking pin that extends between the tool interface and engages a divot in a base of the washer.

These and other aspects of the present system and method will be apparent after consideration of the Detailed Description and Figures herein.

### DRAWINGS

Non-limiting and non-exhaustive embodiments of the present invention, including the preferred embodiment, are described with reference to the following figures, wherein like reference numerals refer to like parts throughout the various views unless otherwise specified.

FIG. 1a is a perspective view of a torque-limiting nut consistent with the technology of the present application.

FIG. 1b is a perspective view of a torque-limiting nut consistent with the technology of the present application.

FIG. 2 is an exploded perspective view of the torque-limiting nut of FIG. 1a.

FIG. 3 is another exploded view of the torque-limiting nut of FIG. 1a.

FIG. 4 is a cross-sectional view of a portion of the torque-limiting nut of FIG. 1a.

FIG. 5 is a view the connection between a threaded component and a tool interface of the torque-limiting nut of FIG. 1a.

FIGS. 6 and 7 are cross-sectional views of FIG. 5 with force components regarding tightening and loosening the torque-limiting nut of FIG. 1a.

FIG. 8 is an exploded, perspective view of another torque-limiting nut consistent with the technology of the present application.

FIG. 9 is an exploded, perspective view of a torque-limiting nut with a reverse thread protector consistent with the technology of the present application.

FIG. 10 is a view of the tool interface of FIG. 9.

FIG. 11 is a detail of the interface between the tool interface and washer of FIG. 9.

FIG. 12 is an exploded, perspective an exploded, perspective view of a torque-limiting nut with another reverse thread protector consistent with the technology of the present application.

FIG. 13 a detail of the tool interface and washer of FIG. 12.

FIG. 14 is a partially exploded, perspective an exploded, perspective view of a torque-limiting nut with another reverse thread protector consistent with the technology of the present application.

### DETAILED DESCRIPTION

The technology of the present application will now be described more fully below with reference to the accompanying figures, which form a part hereof and show, by way of illustration, specific exemplary embodiments. These embodiments are disclosed in sufficient detail to enable those skilled in the art to practice the technology of the present application. However, embodiments may be implemented in many different forms and should not be construed as being limited to the embodiments set forth herein. The following detailed description is, therefore, not to be taken in a limiting sense.

The technology of the present application is described with specific reference to a reverse threading protector for a spindle nut for a vehicle. However, the technology described herein may be used with applications other than those specifically described herein. For example, the technology of the present application may be applicable to any device where reverse threading is of concern. Moreover, the technology of the present application will be described with relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

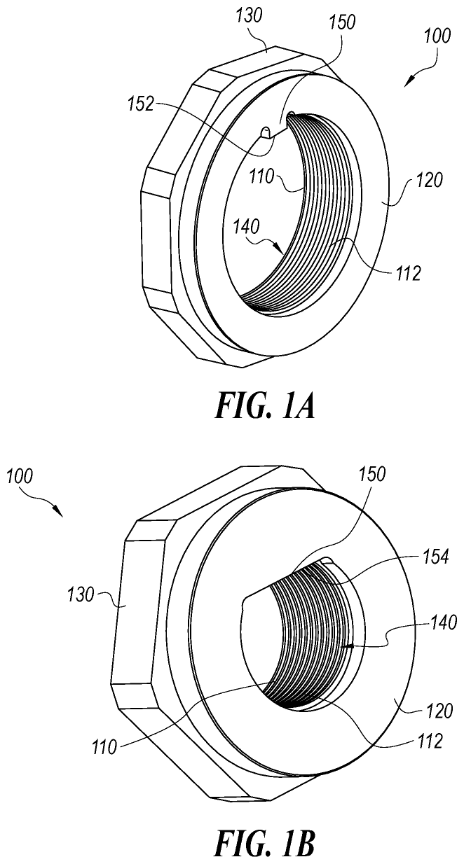

With reference now to FIGS. 1a and 1b, views of a torque-limiting nut assembly 100 consistent with the technology of the present application are provided. In the exemplary embodiments, the torque-limiting nut is a torque-limiting spindle nut 100 as it is designed to engage a spindle to seat a wheelend assembly. Generally, however, the terms torque-limiting nut and torque-limiting spindle nut are used interchangeably. The torque-limiting spindle nut 100 comprises a threaded component 110, a washer 120, and a tool interface 130. The torque-limiting spindle nut 100 has a bore 140 and the threaded component 110 has internal threads 112 along the bore 140. The internal threads 112 are shaped to engage corresponding threads on the spindle in this particular example. However, the torque-limiting spindle nut assembly 100 may be configured for other applications. The washer 120 of the torque-limiting spindle nut 100 includes an anti-rotation device 150. The anti-rotation device 150 may be a tang 152, as shown in FIG. 1a, or a flat 154, as shown in FIG. 1b. The anti-rotation device 150 is shaped to engage a similar anti-rotation feature on the device to which the threaded component 110 is threaded, such as, for example, a spindle. Other key/keyway type of arrangements are possible, and the tang 152 and flat 154 are but two examples.

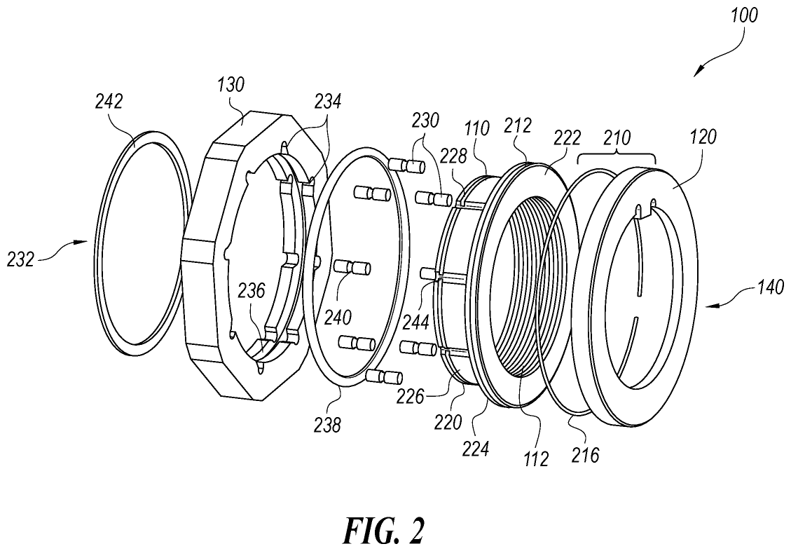

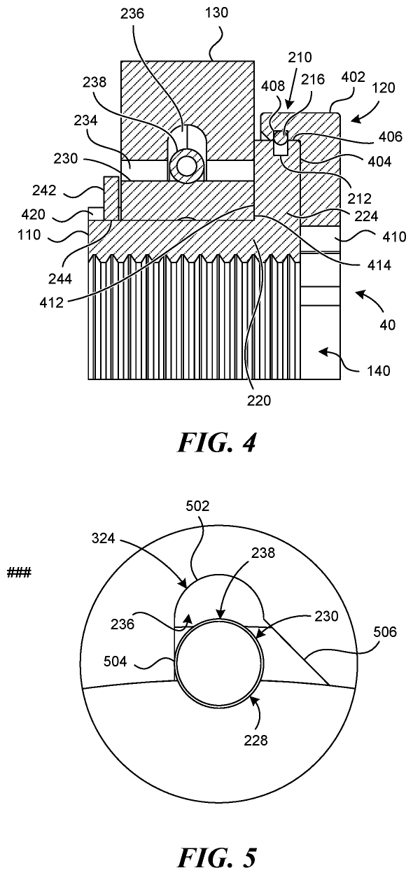

FIG. 2 shows an exploded view of the torque-limiting spindle nut 100. The torque-limiting spindle nut 100 includes the threaded component 110, the washer 120, and the tool interface 130, which is presently shown as an octal tool interface, although any tool interface is possible. As will be explained further below, the washer 120 and the threaded component 110 are unitized by a retaining device 210, which includes a groove 212 on the outer diameter of the threaded component 110, an aligned groove on an inner surface of the washer 120 (shown below in FIG. 4), and a retaining ring 216 configured to fit in both the groove 212 and the aligned groove (shown in FIG. 4 below) to unitize the threaded component 110 and washer.

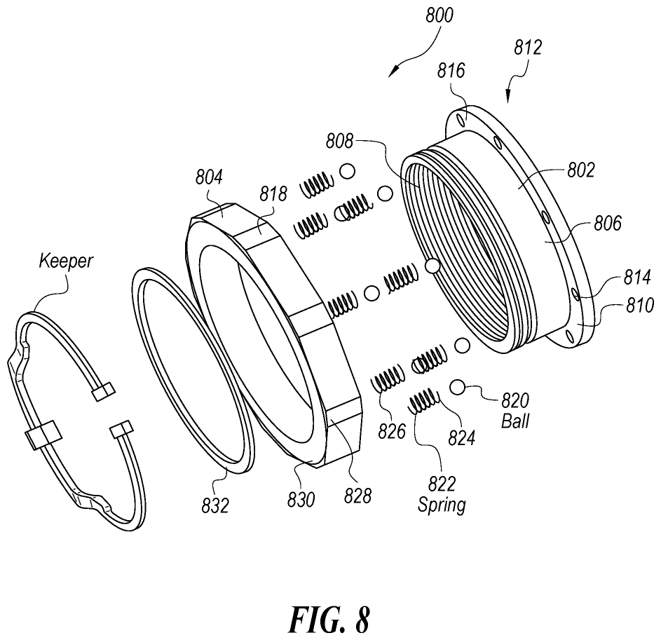

The threaded component 110 has a cylindrical main body 220 that has a bore 140 with internal threads 112. The cylindrical main body has a washer side 222 that terminates in a flanged portion 224. The groove 212 is formed on the outer diameter of the flanged portion 224 of the threaded component 110. The cylindrical main body has an outer sidewall 226 with a plurality of axially extending detents 228 in the outer sidewall 226. The axially extending detents 228 are sized to fit a corresponding plurality of engagement members 230, which are pins 230 in this exemplary embodiment. The pins 230 are shown as elongated cylindrical members, but could be balls, such as is shown in FIG. 8, or other shapes. The description herein relates to the embodiment where the engagement members 230 are pins 230 as shown.

The tool interface 130 has an internal bore 232 shaped to cooperatively engage the cylindrical main body 220 of the threaded component 110. The internal bore 232 has a plurality of axially extending recesses 234 that align, generally, with the plurality of axially extending detents 228. The plurality of pins 230 engage both the detents 228 and the recesses 234, as will be explained further below. The internal bore 232 also has a spring groove 236. The spring groove 236 is shown approximately halfway along the internal bore 232, but could be arranged anywhere along the internal bore 232. The spring groove 236 is open to the recesses 234. An elastic member 238, such as a garter spring, is arranged in the spring groove 236. The elastic member 238 provides a compressive force tending to seat the pins 230 into the detents 228. The pins 230, in certain embodiments, may or may not have a seating groove 240 sized to engage the elastic member 238. A unitization ring 242 engages a unitization channel 244 in the outer sidewall 226 of the cylindrical main body 220. The unitization ring 242 inhibits the tool interface 130 from being removed from the threaded component 110. In certain embodiments, the threaded component 110 may have a crimped or rolled lip at a top edge of the cylindrical main body 220 rather than the unitization ring 242.

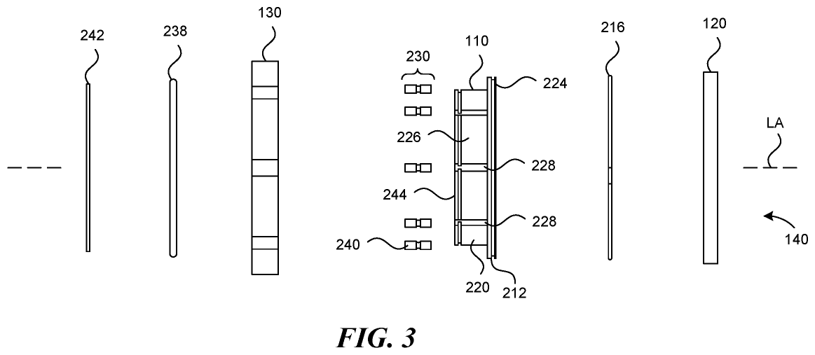

FIG. 3 shows another exploded view of the torque-limiting spindle nut 100. FIG. 3 shows the threaded component 110, the washer 120, the tool interface 130, the retaining ring 216, the cylindrical main body 220 having a flanged portion 224 with a groove 212 in the outer diameter and a unitization channel 244, the outer sidewall 226 with the plurality of axially extending detents 228, the plurality of pins 230, the elastic member 238, and the unitization ring 242.

FIG. 4 shows a cross-sectional view of the torque-limiting spindle nut 100. As can be seen best in FIG. 4, the washer 120 has an outer diameter sidewall 402 and base surface 404 extending radially inwardly. The outer diameter sidewall 402 has an inner surface 406 with an aligned groove 408. The aligned groove 408 is aligned with the groove 212 on the outer diameter of the threaded component 110. The retaining ring 216 fits in both the groove 212 and the aligned groove 408 and is the retaining device 210 that unitizes the washer 120 and the threaded component 110. The base surface 404 has a base surface bore 410 with a diameter equal to or greater than the diameter of the bore 140 of the threaded component 110. The outer diameter sidewall 402 and base surface 404 are sized and shaped to receive the flanged portion 224 of the threaded component 110.

The tool interface 130 has a bottom surface 412 that engages a top surface 414 of the flanged portion. The tool interface 130 spring groove 236 is shown with the elastic member 238, which is shown in this example as garter spring 238. The elastic member 238 provides a compressive force against the pin 230 tending to seat the pins 230 into the axially extending detents 228 of the threaded component 110.

FIG. 4 also shows the unitization ring 242 in the unitization channel 244. As mentioned above, the unitization ring 242 may be replaced by crimping or rolling a top edge 420 of the cylindrical main body 220 after the tool interface 130 is fitted onto the threaded component 110.

FIG. 5 shows a detail of the engagement between the tool interface 130 and the threaded component 110. FIG. 5 shows a single detent 228 and recess 234 with a pin 230. The elastic member 238 in the spring groove 236 is shown providing a compressive force on the pin 230 tending to seat the pin 230 in the detent 228. The recess 234 is open to the spring groove 236. The recess 234 has a pin seat 502 and a radially extending recess wall 504, which extends substantially 90° from the tangent of the internal bore, extending from the pin seat 502 to the internal bore 232 (see FIG. 2). The recess 234 has a second recess wall 506 angled with respect to the radially extending recess wall 504. The angle formed with the radially extending recess wall 504 may be about 25 to 50° in certain embodiments and between about 10 to 85° in other embodiments. Preferably, the angle between 30 and 60° and is about 45° in the present example.

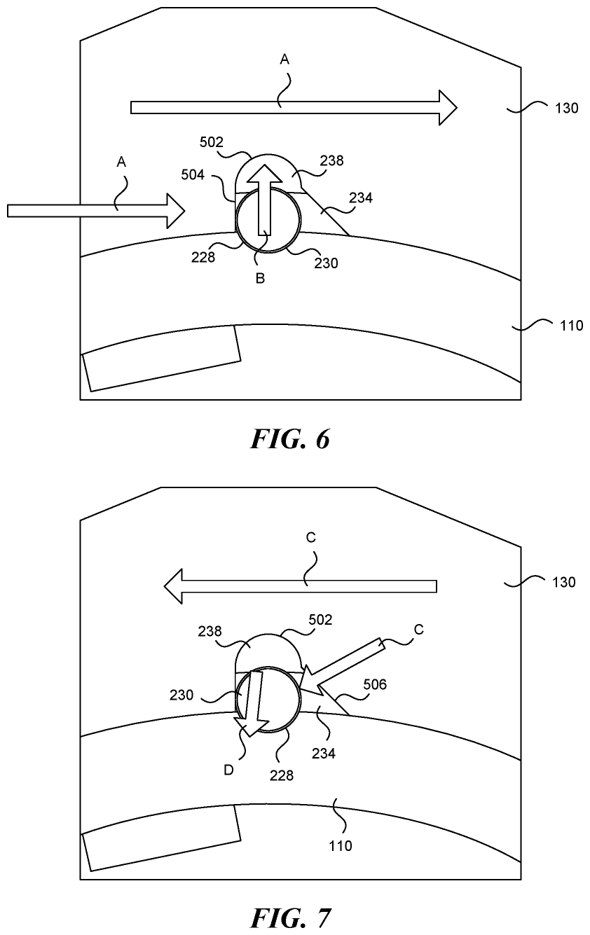

Tightening the torque-limiting spindle nut on a spindle is explained with reference to FIG. 6. FIG. 6 shows a cross-sectional view of the threaded component 110 and tool interface 130 at a single pin 230. The pin 230 is set in detent 228 of the threaded component 110 and the recess 234 of the tool interface 130. The elastic member 238 provides a compressive force tending to seat the pin 230 in the detent 228. A force is applied to the tool interface 130 rotating the tool interface 130 in the direction shown by arrow A. The radially extending recess wall 504 contacts the pin 230 and the elastic member 238, compresses the pin 230 into the detent 228 causing a frictional fit between the tool interface 130 and the threaded component 110. As the tool interface 130 rotates, the frictional force needed as the nut tightens on the spindle increases. The force, as shown by arrow B, acts against the compressive force of the elastic member 238. At a predetermined force (the torque limit), the rotational force unseating the pin 230 overcomes the compressive force of the elastic member 238 and the pin 230 move out of the detent 228 and at least partially into the pin seat 502. Once the pin 230 moves from the detent 228, the tool interface 130 is not frictionally engaged with the threaded component 110 such that additional rotation of the tool interface 130 does not cause additional tightening of the threaded component 110 on the spindle.

Loosening the torque-limiting spindle nut 100 from a spindle is explained with reference to FIG. 7. FIG. 7 shows a cross-sectional view of the threaded component 110 and tool interface 130 at a single pin 230. The pin is seated in the detent 228, but at the maximum torque. When loosening the nut 100, a rotational force is applied to the tool interface 130, as shown by arrow C. Initially, the rotation of the tool interface 130 is at the torque limit and the pin 230 would initially move against the elastic member 238 tending to disengage the pin 230 from the detent 228. However, the second recess wall 506 is angled such that as the tool interface 130 rotates in the direction shown by arrow C, the pin 230 contacts second recess wall 506 that pushes the pin 230, as shown by arrow D, into detent 228 causing a frictional engagement between the tool interface 130 and the threaded component 110. Thus, the torque-limiting spindle nut 100 may be disengaged from the spindle.

FIG. 8 shows an exploded, perspective view of a portion of another torque-limiting spindle nut 800. FIG. 8 shows the threaded component 802 and tool interface 804. The threaded component 802 has a cylindrical main body 806 with an internally threaded bore 808. The threaded component 802 has an annular and radially extending flanged portion 810 at a first end 812 of the cylindrical main body 806. The flanged portion 810 has a plurality of spaced detents 814 in a tool interface surface 816 of the flanged portion 810.

The tool interface 804 has a plurality of axially extending recesses 818 corresponding to the plurality of spaced detents 812. The recesses 818, in certain embodiments, are holes in the tool interface 804. A plurality of engaging members 820, such as balls 820 shown, reside in the detents 814 and extend, at least in part, into the recesses 818, or holes 818. A plurality of compression members 822 are in the axially extending recesses 818, or holes 818, with a first end 824 contacting the engaging members 820 and a second end 826, opposite the first end 824, engaging a lip 828, or hole bottom 828, on a distal end 830 of the tool interface 804, and in certain embodiments, the second end 826 may engage the retaining ring 832. The compression members 822, which are shown as coiled springs, provide a compressive force tending to seat the engaging members 820 in the detents 814 forming a frictional engagement between the tool interface 804 and the threaded component 802. When the torque limit is reached, the engaging members 820 push against the compression members 822 and disengage from the detents 814 such that the frictional engagement between the tool interface 804 and threaded component 802 is broken at the torque limit.

As can be appreciated from the figures above, the threaded component when engaged with the spindle is held by the friction of the threads and the seating force. The vibration of the system, such as vehicle vibration, or other forces may cause the threaded component to reverse thread on the spindle, sometimes referred to as back out or back off.

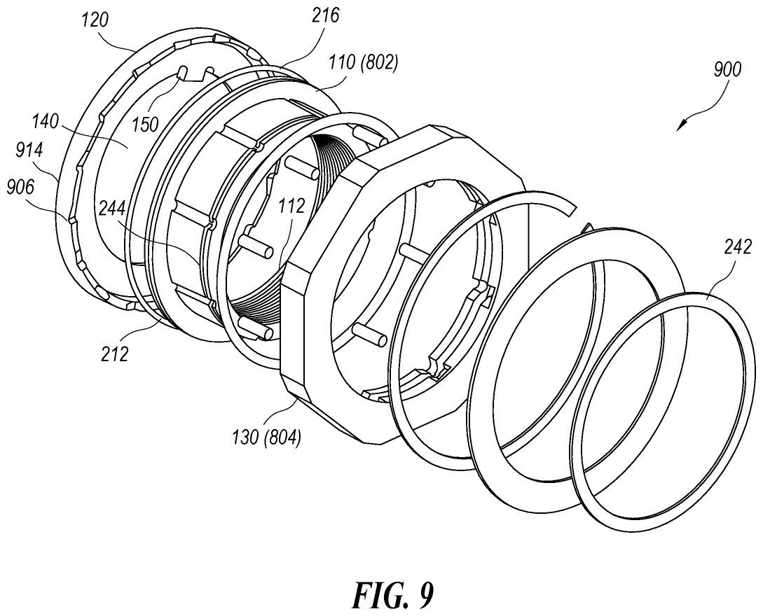

FIG. 9 shows an exploded view of torque-limiting nut assembly 900 consistent with the technology of the present application. The torque-limiting nut assembly 900 is similar to the torque-limiting nuts 100 and 800 described above, and such similarities will not be re-explained herein. Broadly, the torque-limited nut 900 includes, for example, a threaded component 110 (802), a washer 120, and a tool interface 130 (804). The torque-limiting spindle nut 900 has a bore 140 and the threaded component 110 has internal threads 112 along the bore 140. The internal threads 112 are shaped to engage corresponding threads on the spindle in this particular example. However, the torque-limiting spindle nut assembly 100 may be configured for other applications other than a spindle or axle.

The washer 120 and the threaded component 110 are unitized by a retaining device 210 as explained above. The retaining device includes a groove 212 on the outer diameter of the threaded component 110, an aligned groove on an inner surface of the washer 120, and a retaining ring 216 configured to fit in both the groove 212 and the aligned groove to unitize the threaded component 110 and washer.

The tool interface 130 has an internal bore 232 shaped to cooperatively engage the cylindrical main body 220 of the threaded component 110. A unitization ring 242 engages a unitization channel 244 in the outer sidewall 226 of the cylindrical main body 220. The unitization ring 242 inhibits the tool interface 130 from being removed from the threaded component 110. In certain embodiments, the threaded component 110 may have a crimped or rolled lip at a top edge of the cylindrical main body 220 rather than the unitization ring 242.

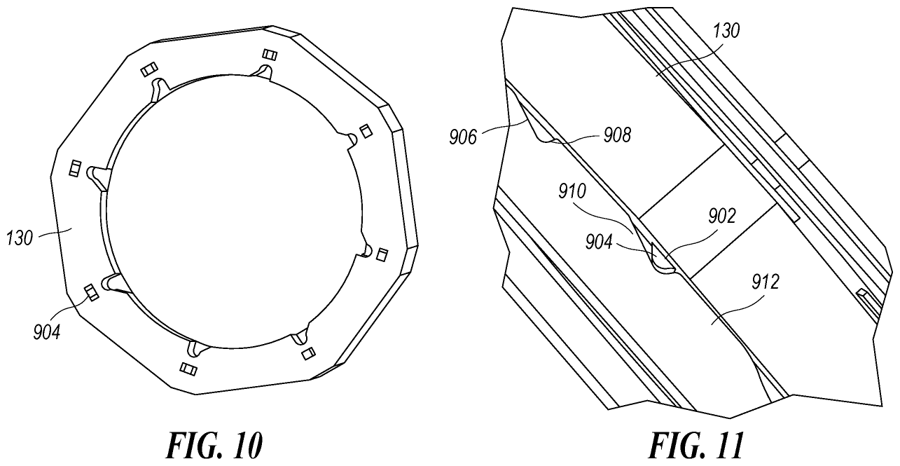

The torque-limiting nut assembly 900 also includes a reverse thread protector 902 as shown in FIGS. 10 and 11. The reverse thread protector 902 comprises a first part 904 on the tool interface 130 and a second part 906 on the washer 120. The first part 904 may be a male component 904 as shown that engages the second part 906 that is a female component 906. The first part 904, in this example, is a protrusion 904, such as the nib 904 as shown, which extends from a surface of the tool interface. The second part 906 is a divot 906, such as the ramp 906 as shown (in FIGS. 11 and 9). The second part 906 is sized to cooperatively engage the first part 904. The ramp 906 may be asymmetrical, as shown, with a first ramp 908 almost parallel with a radius of the washer 120, for example, and a second ramp 910 at an angle to the first ramp 908. The second part 906 is located at a junction between the tool interface and the washer 120, specifically on a circumferential rim 912 located at an outer perimeter edge 914 (FIG. 9) of the washer 120. The first ramp 908 has a high angle (such as between about 80 to 110 degrees with respect to the direction of loosening the threaded portion 110 to resist backing out or reverse threading. The second ramp 910, having a lower angle, such as between about 25 to 75 degrees, allows for tightening the torque-limiting nut assembly 900. The first part 904 and the second part 906 may be reversed such that the second part 906 is on the tool interface 130 and the first part 904 is on the washer 120.

The torque-limiting nut assembly 900 when set onto the spindle, not shown, for example, the first part 904, or male part 904, seats in second part 906, or female part 906. The first ramp 908, when the torque-limiting nut assembly 900 is seated, abuts the first part 904 and provides resistance against reverse threading. Conversely, when seating the torque-limiting nut assembly 900, the first part 904 engages second ramp 910, which requires less force to move the first part over the second part such that the torque-limiting nut assembly 900 may installed.

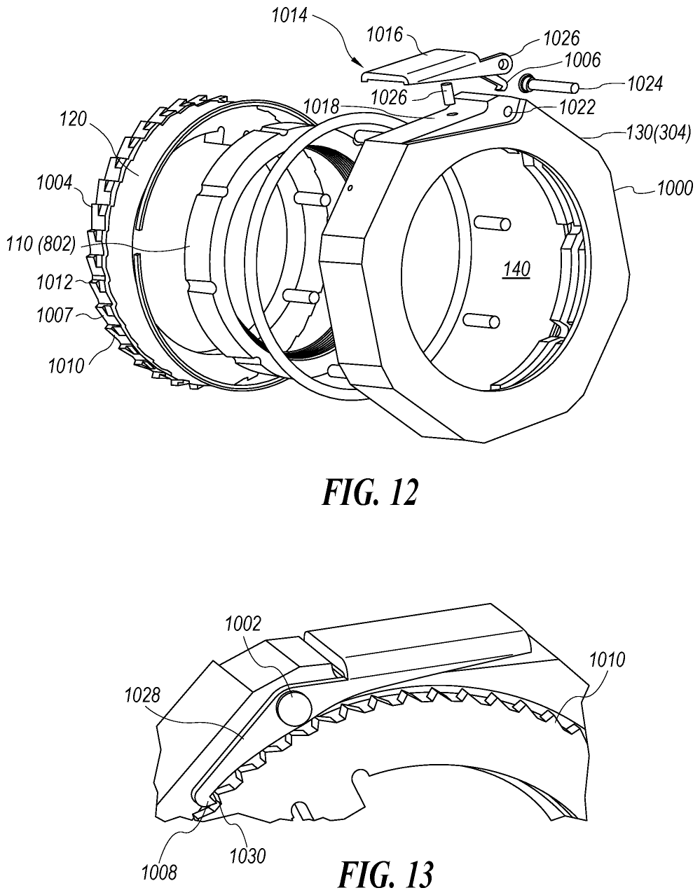

FIG. 12 shows an exploded view of another torque-limiting nut 1000 consistent with the technology of the present application. The torque-limiting nut assembly 1000 is similar to the torque-limiting nuts 100 and 800 described above, and such similarities will not be re-explained herein. Broadly, the torque-limited nut 1000 includes, for example, a threaded component 110 (802), a washer 120, and a tool interface 130 (804). The torque-limiting nut assembly 1000 has a bore 140 and the threaded component 110 has internal threads along the bore 140. The internal threads are shaped to engage corresponding threads on the spindle in this particular example. However, the torque-limiting spindle nut assembly 100 may be configured for other applications other than a spindle or axle.

The torque-limiting nut assembly 1000 has a reverse thread protector 1002 as best seen in FIG. 13 comprising a first part 1004 on the washer 120 and a second part 1006 on the tool interface 130 (although the first and second parts may be reversed). The first part 1004 comprises an outer perimeter sidewall 1007 of the washer 120 having a plurality of divots 1008, which are formed by a plurality of wedge-shaped ramps 1010, or sawtooth protrusion, with a plurality of stop walls 1012. The second part 1006 comprises a pawl mechanism 1014.

The pawl mechanism 1014 comprises a lever 1016 hingedly coupled to the tool interface 130 in a lever seat 1018. The lever seat 1018 has a ramped surface and a bore 1022 through which a pin 1024 extends. The lever 1016 has at least one tang 1026 with a hole (which may be a blind hole) that engage the pin 1024. The ramped surface 1020 has an elastic member 1027 that is under compression and tends to bias the lever 1016 out from or away from the lever seat 1018. The lever seat 1018 may have an elastic member seat (shown but not labeled) in the ramped surface. Extending from the opposing side of the lever 1016 is an arm 1028 that terminates in a hook 1030 with an outer tapered or rounded surface. The lever 1016 and arm 1028 operate as a rocker arm such that when the lever 1016 is seated in the lever seat 1018, the arm 1028 lifts the hook 1030 away from the outer perimeter sidewall 1006 to disengage the pawl mechanism 1014. When the lever 1016 is seated when, for example, the tool (not shown) is engaged over the tool interface 130. When the tool is removed, the elastic member 1026, which may be a compression spring, a coil spring, or the like, biases the lever 1016 away from the lever seat 1018 causing the arm 1028 to descend such that the hook 1030 engages the stop wall 1012. The hook engaging the stop wall resists reverse threading. When the tool, such as a wrench, is installed to thread the torque-limiting nut onto the spindle, in this example, the tool engages the lever that lifts the arm lifts to disengage the pawl mechanism allowing the nut to be tightened.

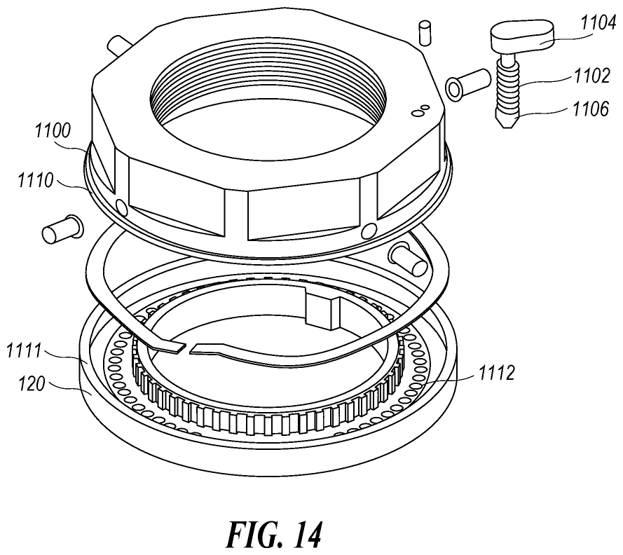

FIG. 14 shows a partially exploded view of a torque-limiting nut assembly 1100, which is in general similar to the torque-limiting nut assemblies above, which will not be re-explained herein. Torque-limiting nut assembly 1100, similar to the above, has at least the tool interface 130 and the washer 120.

The torque-limiting nut assembly 1100 has a reverse thread protector 1102. The torque-limiting nut assembly 1100 may be consistent with any of the above described torque-limiting nuts. The reverse thread protector 1102 comprises a first pack that is a locking pin 1104 that is threaded through a locking bore or channel in the tool interface 130. The rotatable locking pin 1104 terminates in a washer engagement protrusion 1106. The reverse thread protector 1102 has a second part that is a divot in the washer. Specifically, the washer 120 has a base 1108 that engages a base 1110 of the tool interface 130. The base 1108 of the washer 120 has at least one (1), but typically a plurality of, divots 1112 that are sized to cooperatively engage the washer engagement protrusion 1106 at the terminal end of the locking pin 1104. When the torque-limiting nut assembly 1100 is set onto the shaft, such as the spindle axle in this example, the locking pin 1104 is rotated from a free position to an engaged position. In the engaged position, the washer engagement protrusion 1106 seats into a corresponding divot 1112. The washer engagement protrusion seated in the divot 1112 resists rotation of the tool interface 130 with respect to the washer and inhibits reverse threading. To disengage the torque-limiting nut assembly 1100, the locking pin 1104 is rotated in the opposite direction from the engaged position to the free position where the torque-limiting nut assembly 1100 may be loosened (or tightened). In certain embodiments, the locking pin 1104 may be biased by an elastic member 1114, such as a spring, to seat the washer engagement protrusion 1106. When biased by the elastic member 1114, the biasing force may be sufficient to resist reverse threading, but allow intentionally loosening the torque-limiting nut assembly 1100 by a tool on the tool interface. Also, in certain embodiments, the torque-limiting nut assembly 1100 may include a locking pin stop 1116 to inhibit over rotation of the locking pin 1104.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many embodiments of the invention can be practiced without departing from the spirit and scope of the invention, the invention resides in the claims hereinafter appended. Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques. Moreover, all ranges disclosed herein are to be understood to encompass and provide support for claims that recite any and all subranges or any and all individual values subsumed therein. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

What is claimed is:

1. A torque-limiting nut with a reverse thread protector comprising,
a threaded component;
a tool interface having an internal bore sized to receive the cylindrical main body of the threaded component; and
a washer having an annular sidewall, wherein
the threaded component, the tool interface, and the washer are a unitized assembly having a reverse thread protector comprising:
a first part on the tool interface; and
a second part on the washer, wherein the first part and the second part are operatively sized to engage to inhibit the tool interface from reverse threading with respect to the washer.

2. The torque-limiting nut with a reverse thread protector of claim 1 wherein the second part is on an annual sidewall of the washer.

3. The torque-limiting nut with a reverse thread protector of claim 2 wherein the first part is a male component and the second part is a female component wherein the male component and the female component are operatively sized to fit together when the torque-limiting nut with a reverse thread protector is seated.

4. The torque-limiting nut with a reverse thread protector of claim 3 wherein the male component is at least one nib.

5. The torque-limiting nut with a reverse thread protector of claim 4 wherein the at least one nib is a plurality of nibs.

6. The torque-limiting nut with a reverse thread protector of claim 3 wherein the female component is at least one divot.

7. The torque-limiting nut with a reverse thread protector of claim 6 wherein the at least one divot is a plurality of divots.

8. The torque-limiting nut with a reverse thread protector of claim 6 wherein the divot includes a pair of asymmetrical ramps wherein at least one of the asymmetrical ramps is generally parallel to a direction that the male component extends from the tool interface.

9. The torque-limiting nut with a reverse thread protector of claim 1 wherein the second part is on the outer perimeter surface of the washer.

10. The torque-limiting nut with a reverse thread protector of claim 9 wherein the first part comprises a pawl mechanism and the second part comprises a plurality of divots on the outer perimeter surface.

11. A torque-limiting nut with a reverse thread protector comprising,
a threaded component;
a tool interface having an internal bore sized to receive the cylindrical main body of the threaded component; and
a washer having an outer perimeter surface, wherein
the threaded component, the tool interface, and the washer are a unitized assembly having a reverse thread protector comprising:
a first part on the tool interface; and
a second part on the outer perimeter surface of the washer, wherein the first part and the second part are operatively sized to engage to inhibit the tool interface from reverse threading with respect to the washer.

12. The torque-limiting nut with a reverse thread protector of claim 11 wherein the first part comprises a pawl mechanism and the second part comprises a plurality of divots on the outer perimeter surface.

13. The torque-limiting nut with a reverse thread protector of claim 12, wherein each of the plurality of divots is formed by a wedge shaped ramp.

14. The torque-limiting nut with a reverse thread protector of claim 12 wherein the pawl mechanism includes a lever and an arm that terminates in a hook wherein the lever and the arm operate as a rocker arm such that when the lever is seated the arm is raised to disengage the hook from the plurality of divots and when the lever is unseated the arm is lowered to engage the hook with at least one of the plurality of divots.

15. The torque-limiting nut with a reverse thread protector of claim 14 wherein the pawl mechanism includes a lever seat with an elastic member to bias the lever away from the seat.

16. The torque-limiting nut with a reverse thread protector of claim 15 wherein the elastic member is a spring.

17. A torque-limiting nut with a reverse thread protector comprising,
a threaded component;
a tool interface having an internal bore sized to receive the cylindrical main body of the threaded component and a locking bore; and
a washer having a base with at least one divot, wherein
the threaded component, the tool interface, and the washer are a unitized assembly having a reverse thread protector, wherein the reverse thread protector comprises a locking pin that extends through the locking bore and engages the at least one divot in the base of the washer to inhibit the tool interface to inhibit reverse threading.

18. The torque-limiting nut with the reverse thread protector of claim 17 wherein the locking pin is threaded into the locking bore and has an engaged position to inhibit reverse threading and a free position to allow rotating the torque-limiting nut.

19. The torque-limiting nut with the reverse thread protector of claim 18 wherein the tool interface comprises a locking pin stop to prevent over threading the locking pin.

20. The torque-limiting nut with the reverse thread protector of claim 17 wherein the locking pin is spring loaded.
